(19) United States
(12) Patent Application Publication
(10) Pub. No.: US 2021/0238426 A1
(43) Pub. Date: Aug. 5, 2021

(54) PROCESS FOR MAKING DIRECT-RUN DIATOMITE FUNCTIONAL FILLER PRODUCTS

(71) Applicant: EP MINERALS, LLC, Reno, NV (US)

(72) Inventor: George Asante Nyamekye, Sparks, NV (US)

(73) Assignee: EP MINERALS, LLC, RENO, NV (US)

(21) Appl. No.: 16/777,132

(22) Filed: Jan. 30, 2020

(51) Int. Cl. C09C 1/30; C01B 33/18

(52) U.S. Cl. CPC C09C 1/3018; C01P 2002/88; C09C 1/3027; C01B 33/18

(57) ABSTRACT

A method for manufacturing a diatomaceous earth functional filler product with detectable or non-detectable crystalline silica includes the steps of: selecting a diatomaceous earth ore; simultaneously milling and flash-drying the diatomaceous earth ore; beneficiating the milled and flash-dried diamtomaceous earth ore; blending the beneficiated diatomaceous earth ore with a fluxing agent; calcining the blended diatomaceous earth ore and fluxing agent to produce an initial diatomaceous earth powder; air-classifying the initial diatomaceous earth powder to produce a first fraction including the diatomaceous earth functional filler product and a second fraction including coarse particles; further milling the coarse particles to produce additional diatomaceous earth powder; and re-circulating the additional diatomaceous earth powder to blend the additional diatomaceous earth powder with the initial diatomaceous earth powder.

### TECHNICAL FIELD

This disclosure generally relates to processes for making white flux-calcined diatomite functional filler products, which have non-detectable or detectable cristobalite content. More specifically, this disclosure relates to processes for making diatomite functional filler products that are manufactured through direct-run methods, utilizing a combination of a media mill and a classifier.

### BACKGROUND

Diatoms belong to any member of the algal class Bacillariophyceae, with about 12,000 distinct species found in sedimentary deposits in lake (lacustrine origin) and ocean (marine origin) habitats. The diatom cells have a unique feature of being enclosed within a cell wall of amorphous, hydrated biogenic silicon dioxide (silica) called a frustule. These frustules, considered to be in the opal-A phase of silica mineralogy, show a wide diversity in form, but are usually almost bilaterally symmetrical. Because they are composed of silica, an inert material, diatom frustules remain well-preserved over vast periods of time within geologic sediments.

Also deposited with the diatom fossils during their formation are organic contaminants and other minerals, such as clays, volcanic ash, calcite, dolomite, and feldspars. Silica sand in the form of quartz, a form of crystalline silica, may also be deposited in the formation even though the diatomite frustules do not by themselves contain any crystalline silica. It is common to find quartz in marine deposits of diatomite, but some lacustrine deposits of diatomite are free of quartz or contain quartz grains that are easily liberated by milling and drying, followed by separation using mechanical air classification. Quartz grains may also be formed over time as a result of phase conversion from opal-A silica. Namely, following the death of the diatom, the opal-A phase can become partially dehydrated and, in a series of stages, convert from opal-A to other forms of opal with more short-range molecular order and containing less water of hydration, such as the opal-CT and opal-C phases. Over very long periods of time and under suitable conditions, opal-CT can convert to quartz.

The amorphous silica of diatomite, present in the form of opaline diatom skeletons, may also contain alumina, iron, alkali metals and alkali-earth metals. Typical commercial diatomite ores, as determined on an organic-free basis, may show a chemical analysis of silica in the range of about 80 to about 90+wt.-%, alumina (Al₂O₃) in the range of about 0.6 to about 8 wt.-%, iron oxide (Fe₂O₃) in the range of about 0.2 to about 3.5 wt.-%, alkali metal oxides such as Na₂O and MgO in an amount of less than about 1 wt.-%, CaO in the range of about 0.3 to about 3 wt.-%, and minor amounts of other impurities, such as P₂O₅ and TiO₂, for example. In selected deposits, however, the silica concentration may be as high as about 97 wt.-% SiO₂.

In commercial grade ores, the unique fine porosity of frustules in diatomaceous earth, a mineral composed of fossil diatoms, provides for certain product properties, including high surface area, low bulk density, and high absorptive capacity. The intricate pore structure of diatomaceous earth ore, which is composed of macropores, mesopores, and micropores, provides for the wetting and high absorptive capacity necessary in certain formulations involving the use of diatomite products.

For example, a combination of the chemical stability derived from the inert silica composition and the high porosity of the frustules make diatomaceous earth useful in commercial filtration applications. Diatomite products have been used for many years in solid/liquid separation (filtration) in several industries, including beverages (for example beer, wine, spirits, and juice), oils (fats, petroleum), waters (swimming pools, drinking water), chemicals (dry cleaning fluid, TiO₂ additives), ingestible pharmaceuticals (antibiotics), metallurgy (cooling fluids), agro-food intermediates (amino acid, gelatin, yeast), and sugars. Apart from filtration, the unique diatomite properties may also lend it to use as a functional filler material in plastic, insulation, abrasives, paint, paper, asphalt, and as a base in dynamite. Furthermore, diatomite products are useful in the processing of certain commercial catalysts, are used as chromatographic supports, and are also suited to gas-liquid chromatographic methods.

### Processing of Commercial Grade Diatomite Ores

The typical chemical properties of commercial grade natural diatomite ores serving as calcination feed for the manufacturing of diatomite filter aid and functional filler products have been composed of ores with high-grade chemistry. The extractable impurities and the centrifuged wet densities of the filter aid products made from the high-graded ores have historically been considered more desirable than the properties of products made from lower-grade ores. Over the years, diatomite deposits have been high-graded by selectively mining feed ores, typically, with alumina content of less than about 4 wt.-% and iron oxide content of less than about 2 wt.-%. When calcined with fluxing agents, diatomite ores with high-grade chemistry result in white-colored filter aid products and provide for functional filler products with a desirable high whiteness and brightness.

As initially noted above, diatomite products are obtained from the processing of diatomaceous earth ores. Diatomaceous earth ore may include up to about 70% free moisture and various organic and inorganic substances. Thus, before using diatomite in filtration processes or in functional filler applications, the feed material is taken through conditioning processes that may include some or all of the following unit operations: crushing, milling, drying, heavy minerals separation, calcining, and grit separation. For example, a diatomite ore may be crushed, milled, and flash dried to remove moisture and heavy minerals waste to produce natural filter aids (if the feed does not contain significant amounts of organic compounds and extractable metals) or natural functional fillers (if the ore has a natural bright color). In other instances, a diatomite feed may be milled, flash dried to remove moisture, and calcined to drive off organic contaminants and convert soluble inorganic substances into more inert oxides, silicates, or aluminosilicates. The color of the calcined product may turn bright white in the presence of soda ash if the alumina and iron oxide contents of the ore are less than about 5.0 wt.-% and about 2.0 wt.-%, respectively. Calcination may also reduce the density of the final product, which is a desired feature for functional filler applications in paint formulations.

FIG. 1 shows a flow diagram for a process 100 used in a typical diatomite production facility that manufactures fast flow rate filtration media and functional filler by-products utilizing low-impurity diatomite ore as feed. The process begins (step 102) with the selection of the high-grade, low-impurity diatomaceous earth ore from the mine, which typically has a moisture content in the range of about 30 wt.-% to about 60 wt.-%.

Next, the manufacturing process 100 at the production plant involves the crushing of the feed ore to prepare it for drying. The most economical and practical means of drying natural diatomite ores is through the simultaneous milling and flash drying (step 104) of the feed material, which results in the deagglomeration of the consolidated material and removal of moisture to about 2 to about 10 wt.-%. Flash drying may involve single-stage or double-stage processing. Single-stage flash drying processes may incorporate recycling of part of the dried material into the moist feed material to reduce the moisture content of the feed entering the dryer to ensure the moisture target of the product is achieved in a single pass. Alternatively, a single-stage flash dryer may incorporate a static cone classifier where partially dried particles are classified out of the dryer discharge material and returned to the feed entering the dryer. Double-stage flash drying involves either two stages of simultaneous milling and drying of the feed material or a first stage of simultaneous milling and drying and a second stage of pneumatic hot air conveyance drying. The use of an inline static classifier provides for a dried product with minimum particle degradation and therefore results in a lighter density material than the double-stage flash drying system or single-stage recycling system, because the retention time of particles in the process in minimized.

Next, physical beneficiation of the feed to remove heavy minerals and other waste impurities (step 106) is effected by employing different forms of mechanical air classifiers. Crystalline silica minerals, such as quartz, can be removed during this stage of the process 100. Heavy minerals such as sand, chert, and other particles are also separated. The beneficiation step 106 helps to remove grits from the feed ore but does not significantly impact the chemistry and density of the feed material.

Next, a fluxing agent, typically soda ash (sodium carbonate), is pneumatically blended into the beneficiated powder (step 150) and then collected into a feed bin to provide for a consistent feed rate of material into a rotary kiln for thermal sintering of the powder (also, referred to as flux-calcination) (step 108). This thermal treatment results in the combustion and removal of organic matter in the ore, aids in the agglomeration of finer and coarse particles, and reduces product surface area through the loss of some porosity, with a resultant increase in material permeability. Moreover, flux-calcination produces functional filler grade products with attractive optical properties (high whiteness). In cases where a straight calcination process (calcination in the absence of fluxing agent) is used, the resultant diatomite products show poor optical properties and therefore have limited use in most functional filler applications. The flux-calcination step 108 is carried out in a temperature range of about 870° C. to about 1250° C. and partially or fully dehydrates the naturally-occurring hydrated amorphous silica structure of the diatomite. Calcination is carried out by the thermal treatment of the diatomaceous earth ore in a rotary kiln or rotary calciner.

The kiln discharge for the flux-calcined material is usually agglomerated and must be taken through dispersion fans to generate fine diatomite powder that usually shows a very broad particle size distribution. As such, in order to produce a fast flow rate filter aid product that is acceptable for filtration applications, the process 100 continues with the powder being subjected to mechanical or air classification (step 110) to remove about 10 to about 30 wt.-% of the finer fraction as functional filler product (step 112) in a baghouse, and the coarser fraction is collected in a cyclone as a fast flow rate filter aid (step 114) with significantly enhanced permeability. Optionally, very coarse particles may be further dispersed and classified to control the particle size requirement of the filter aid fraction.

The use of diatomite as a functional filler has gained popularity in various applications in recent times, and the demand for this fine grade product has increased significantly. Currently, the functional filler grades are produced in conjunction with, and as an integral part of the filter aid production, as evidenced by process 100. Because the functional filler yield in these processes may be less than about 30 wt.-% of the total production, more filter aid needs to be produced in order to meet the increased filler demand by the industry. While the demand for the diatomite functional filler products has been on the rise, the use of diatomite filter aids in filtration applications has been on the decline in recent years due to the introduction of new filtration technologies, such as membranes. The disproportionate demand for functional fillers over filter aid products has created a problem for diatomite manufacturers, where there is a surplus of filter aid products and shortage of functional filler grades.

Various attempts have been made to improve the yield of functional filler products during the production of filter aids by installing high-efficiency classifiers to recover more finer particles from kiln discharge products and milling down part of the coarser flux-calcined filter aid products. This approach to increasing functional filler yield, however, results in poor product quality with respect to color. This is because filter aid products are predominantly coarse particles with a less bright color in comparison to the finer co-produced filler particles. Coarser particles are made up of bigger size diatoms and the diffusion of soda ash into their mass to provide the white bright color during calcination in the rotary kiln is not as efficient as those of smaller diatoms that make up the filler grades. Moreover, milling down part of the coarser flux-calcined filter aid products additionally results in an undesirably increase in density of the functional filler product, along with a partial loss of functionality. Therefore, milling of the filter aid product to convert it into finer particles to increase the functional filler grade does not solve the increased functional filler demand problem.

Accordingly, it would be desirable to provide a solution that overcomes the conventional method of diatomite functional filler production through co-production with filter aid products. Beneficially, the solution would involve a process that converts substantially all of the flux-calcined kiln discharge material into functional filler grades with the desired product specifications. With such a solution, functional fillers could be made as direct-run products without generating any unwanted filter aids that create the above-noted supply imbalance. Furthermore, other desirable features and characteristics of the manufacturing methods disclosed herein will become apparent from the subsequent detailed description and the appended claims, taken in conjunction with the accompanying drawings and the preceding background.

### BRIEF SUMMARY

This summary is provided to describe select concepts in a simplified form that are further described in the detailed description. This summary is not intended to identify key or essential features of the claimed subject matter, nor is it intended to be used as an aid in determining the scope of the claimed subject matter.

In one exemplary embodiment, a method for manufacturing a diatomaceous earth functional filler product includes the steps of: selecting a diatomaceous earth ore; simultaneously milling and flash-drying the diatomaceous earth ore; beneficiating the milled and flash-dried diamtomaceous earth ore; blending the beneficiated diatomaceous earth ore with a fluxing agent; calcining the blended diatomaceous earth ore and fluxing agent to produce an initial diatomaceous earth powder; air-classifying the initial diatomaceous earth powder to produce a first fraction including the diatomaceous earth functional filler product and a second fraction including coarse particles; further milling the coarse particles to produce additional diatomaceous earth powder; and re-circulating the additional diatomaceous earth powder to blend the additional diatomaceous earth powder with the initial diatomaceous earth powder.

In another exemplary embodiment, disclosed is a method for manufacturing a diatomaceous earth functional filler product having non-detectable crystalline silica that includes the steps of: selecting a diatomaceous earth ore with alumina content from about 3.0 and about 4.5 wt.-% and iron oxide content of from about 1.2 to about 2 wt.-% and a centrifuged wet density of less than about 0.32 g/l (about 20.0 lb/ft³); simultaneously milling and flash-drying the diatomaceous earth ore; beneficiating the milled and flash-dried diatomaceous earth ore; blending the beneficiated diatomaceous earth ore with a fluxing agent; solubilizing the fluxing agent with atomized water; calcining the blended diatomaceous earth ore and solubilized fluxing agent at a temperature of about 677° C. to about 1093° C. (about 1250° F. to about 2000° F.) for a time period ranging from about 20 minutes to about 40 minutes to produce an initial diatomaceous earth powder; air-classifying the initial diatomaceous earth powder to produce a first fraction including the diatomaceous earth functional filler product and a second fraction including coarse particles; further milling the coarse particles to produce additional diatomaceous earth powder; and re-circulating the additional diatomaceous earth powder to blend the additional diatomaceous earth powder with the initial diatomaceous earth powder.

In yet another exemplary embodiment, disclosed is a method for manufacturing a diatomaceous earth functional filler product having detectable crystalline silica that includes the steps of: selecting a diatomaceous earth ore with alumina content of less than about 3.0 wt.-% and iron oxide content of less than about 1.7 wt.-% and a centrifuged wet density of less than about 0.32 g/l (about 20.0 lb/ft³); simultaneously milling and flash-drying the diatomaceous earth ore; beneficiating the milled and flash-dried diatomaceous earth ore; blending the beneficiated diatomaceous earth ore with a fluxing agent; calcining the blended diatomaceous earth ore and fluxing agent at a temperature of about 760° C. to about 1177° C. (about 1400° F. to about 2150° F.) for a time period ranging from about 20 minutes to about 40 minutes to produce an initial diatomaceous earth powder; air-classifying the initial diatomaceous earth powder to produce a first fraction including the diatomaceous earth functional filler product and a second fraction including coarse particles; further milling the coarse particles to produce additional diatomaceous earth powder; and re-circulating the additional diatomaceous earth powder to blend the additional diatomaceous earth powder with the initial diatomaceous earth powder.

### BRIEF DESCRIPTION OF THE DRAWING FIGURES

The present disclosure will hereinafter be described in conjunction with the following drawing figures, wherein like numerals denote like elements, and wherein:

FIG. 1 is a flow diagram of a conventional (prior art) diatomite manufacturing process with co-production of functional filler products;

FIG. 2A is a flow diagram of a direct-run diatomite functional filler manufacturing process having non-detectable crystalline silica, in accordance with an exemplary embodiment of the present disclosure;

FIG. 2B is a flow diagram of a direct-run diatomite functional filler manufacturing process having detectable crystalline silica, in accordance with an exemplary embodiment of the present disclosure;

FIG. 3 is a Differential Scanning calorimetry (DSC) plot showing the presence of opal-C phase with a phase transition at between 140° C. and 175° C. during heating with no peak for cristobalite in a flux-calcined diatomite sample;

FIG. 4 is a DSC plot showing two peaks, which indicates a mixture of opal-C phase and cristobalite in a flux-calcined diatomite sample; and

FIG. 5 is a system diagram for a classification and milling circuit employed in the manufacturing of direct-run functional filler products, in accordance with an exemplary embodiment of the present disclosure.

### DETAILED DESCRIPTION

The following detailed description is merely exemplary in nature and is not intended to limit the invention or the application and uses of the invention. As used herein, the word “exemplary” means “serving as an example, instance, or illustration.” Thus, any embodiment described herein as “exemplary” is not necessarily to be construed as preferred or advantageous over other embodiments. All of the embodiments described herein are exemplary embodiments provided to enable persons skilled in the art to make or use the invention and not to limit the scope of the invention, which is defined by the claims. Furthermore, there is no intention to be bound by any expressed or implied theory presented in the preceding technical field, background, brief summary, or the following detailed description.

Unless specifically stated or obvious from context, as used herein, the term “about” is understood as within a range of normal tolerance in the art, for example within 2 standard deviations of the mean. “About” can be understood as within 10%, 5%, 1%, or 0.5% of the stated value. Unless otherwise clear from the context, all numerical values provided herein are modified by the term “about.”

The present disclosure describes processes for manufacturing direct-run white flux-calcined diatomaceous earth functional filler products. In particular, in a first embodiment, the present disclosure describes processes for manufacturing functional filler products containing diatomaceous earth, the diatomaceous earth derived from ores that have been specifically selected for their natural alumina and iron oxide contents and then processed with feed preparation and thermal treatment methods that tend to suppress the mechanism that triggers the generation of cristobalite in the presence of soda flux during calcination. The present disclosure also describes, in a second embodiment, direct-run functional filler products containing diatomaceous earth, the diatomaceous earth products containing crystalline silica in the form of quartz or cristobalite that is produced following alternative methods of feed preparation and calcination.

Table 1, below, provides exemplary physical and chemical properties of 1.0. Hegman functional filler products (see below section “Methods of Characterizing Direct-Run Diatomite Functional Filler Products” for a description of the Hegman gauge), in accordance with the first embodiment of the present disclosure. Versions of the non-detectable (ND) and the detectable (MW) crystalline silica direct-run products are given. Additionally, Table 2, below, provides exemplary physical and chemical properties of 2.0. Hegman filler products, likewise with versions of the ND and MW crystalline silica products, in accordance with the second embodiment of the present disclosure. It should be noted that the values given in Tables 1 and 2 are approximate, and it should be appreciated that the values may vary up to +/−10%.

TABLE 1
Physical and Chemical Properties of Direct-Run 1.0 Hegman Filler Products

| | Direct-Run Silica Functional | | Direct-Run Functional | |
|---|---|---|---|---|
| | Filler Product With Non- | | Filler Product With | |
| | Detectable Crystalline Silica | | Detectable Crystalline Silica | |
| Product | ND 27 | | MW 27 | |
| Filler Yield (%) | 93 | 97 | 94 | 95 |
| Y | 89.6 | 87.1 | 92.1 | 92.6 |
| L* | 95.8 | 93.5 | 96.9 | 97.1 |
| a* | 0.34 | 0.29 | −0.04 | 0.02 |
| b* | 1.25 | 1.15 | 1.58 | 1.88 |
| GCOA (%) | 140 | 140 | 121 | 132 |
| D10 (μm) | 11.9 | 12.0 | 12.4 | 12.2 |
| D50 (μm) | 27.3 | 28.3 | 28.8 | 28.5 |
| D90 (μm) | 49.9 | 51.5 | 51.9 | 52.3 |
| D95 (μm) | 60.1 | 61.1 | 63.0 | 62.8 |
| CWD (lb/ft³) | 21.7 | 20.5 | 21.1 | 20.8 |
| +325 Mesh Fraction | 3.7 | 3.9 | 3.7 | 3.5 |
| Hegman | 1.0 | 1.0 | 1.0 | 1.0 |
| % Al₂O₃ | 4.4 | 3.1 | 2.2 | 2.9 |
| % Fe₂O₃ | 1.8 | 1.4 | 1.2 | 1.4 |
| % Cristobalite | ND | ND | 24.2 | 20.1 |
| % Quartz | ND | ND | ND | ND |

TABLE 2
Physical and Chemical Properties of Direct-Run 2.0 Hegman Filler Products

| | Direct-Run Non-Detectable | | Conventional Direct- | |
|---|---|---|---|---|
| | Crystalline Silica Filler Product | | Run Filler Product | |
| Product | ND 25 | | MW 25 | |
| Filler Yield (%) | 95 | 94 | 93 | 96 |
| Y | 90.0 | 89.7 | 93.2 | 92.7 |
| L* | 96.4 | 95.9 | 97.3 | 97.1 |
| a* | 0.60 | −0.10 | −0.07 | −0.14 |
| b* | 2.60 | 1.60 | 1.45 | 1.96 |
| GCOA (%) | 121 | 130 | 143 | 141 |
| D10 (μm) | 6.9 | 6.9 | 7.4 | 7.6 |
| D50 (μm) | 12.0 | 14.4 | 14.3 | 17.4 |
| D90 (μm) | 21.1 | 29.8 | 28.6 | 36.2 |
| D95 (μm) | 26.1 | 38.6 | 37.2 | 45.8 |
| CWD (lb/ft³) | 24.9 | 23.5 | 23.8 | 23.0 |
| +325 Mesh Fraction | 1.1 | 1.5 | 1.20 | 0.70 |
| Hegman | 2.0 | 2.0 | 2.0 | 2.5 |
| % Al₂O₃ | 4.5 | 3.3 | 1.7 | 2.9 |
| % Fe₂O₃ | 1.7 | 1.6 | 1.2 | 1.5 |
| % Cristobalite | ND | ND | 27.3 | 18.7 |
| % Quartz | ND | ND | ND | ND |

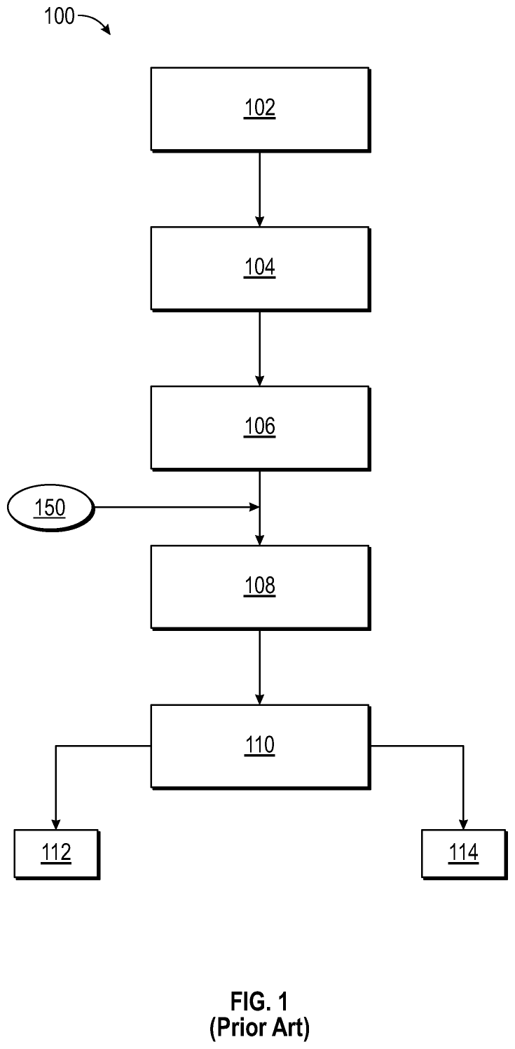

As initially noted above, the products described in Tables 1 and 2, above, originate as diatomaceous earth ore prior to processing. Diatomaceous earth ore is composed of diatoms that occur naturally with varying degrees of shape and size. On average, the particle size distribution of these diatoms range from about 1 and about 100 microns when prepared as feed for calcination in a rotary kiln. As shown in process 100 of FIG. 1, the manufacture of diatomite filter aid and filler products involves the introduction of fine soda ash powder 150 into the feed during flux-calcination (step 108) to achieve a white, bright colored product at the kiln discharge. The chemical reaction of soda ash with the diatom particles during calcination is a mass transfer process, resulting in finer diatom particles being relatively brighter than coarser diatom particles. Brighter, fine functional filler products are therefore obtained from sifting of the finer diatom particles after the flux-calcination process. In the prior art, milling the coarser diatoms to improve the filler yield is usually avoided, because, as noted above, the inner part of the large diatoms are not completely flux-calcined and thus exhibit a less brighter color, which may not be suitable for use as a functional filler product.

In accordance with the methods of the present disclosure, and in contrast to the conventional diatomite functional filler products that are manufactured as by-products from the production of white flux-calcined filter aids, the direct-run ND and MW functional filler products described in Tables 1 and 2 are made by converting all (or substantially all) of the flux-calcined material from the rotary kiln into functional filler grades. This novel approach of generating direct-run functional filler products is made possible by selectively milling and classifying the flux-calcined material without degrading the white color of the product. The color of the product is maintained in these manufacturing methods as a result of novel methods of preparing the diatomaceous earth feed ore for calcination, which enhances the mass diffusion of soda ash into both smaller and larger diatoms. The methods of both the first and second embodiments of the present disclosure are now described below.

Methods of Manufacturing Direct-Run Functional Filler Products with ND Crystalline Silica

In the first embodiment of the present disclosure, methods for manufacturing direct-run functional filler products with ND crystalline silica begin with the selection of a diatomaceous earth ore that possesses alumina content in the range of about 3.0 to about 4.5 wt.-% and iron oxide content in the range of about 1.2 to about 2.0 wt.-%. Any alumina or iron oxide chemistry below these ranges has the tendency to form cristobalite during the flux-calcination process, while any chemistry above these ranges results in a product with unacceptable color. In addition to chemistry, the methods also involve selecting a diatomaceous earth ore with a density of less than about 20 lb/ft³ (about 0.32 g/ml), which compensates for the loss in density of the functional filler product during the direct-run milling operation. Table 3, below, provides some exemplary chemical and physical properties of ores that are suitable for use in accordance with this first embodiment (wherein CWD refers to centrifuged wet density).

TABLE 3
Exemplary Chemical and Physical Properties
of the Diatomite Ore Kiln Feed

| CWD | CWD | SiO₂ | Al₂O₃ | Fe₂O₃ |
|---|---|---|---|---|
| (lb/ft³) | (g/ml) | (wt.-%) | (wt.-%) | (wt.-%) |
| 19.5 | 0.31 | 91.9 | 4.41 | 2.01 |
| 17.3 | 0.28 | 91.5 | 4.51 | 2.03 |
| 16.9 | 0.27 | 92.8 | 3.57 | 1.58 |
| 16.6 | 0.27 | 92.1 | 3.95 | 1.78 |
| 17.3 | 0.28 | 92.2 | 3.83 | 1.67 |
| 18.1 | 0.29 | 91.9 | 4.01 | 2.01 |

In general, previously-known diatomite functional filler production utilizes ores with alumina content in the range of about 1.0 to about 3.0 wt.-% and iron oxide content of less than about 1.5 wt.-% in order to achieve the white, bright color specifications required of the functional filler products. As such, a unique aspect of the present embodiment is the ability to utilize ores that have relatively higher alumina and iron oxide chemistries in comparison to those used in the prior art, and yet generate flux-calcined material that exhibits a color brightness similar to that of the conventionally-used low alumina and iron oxide ores.

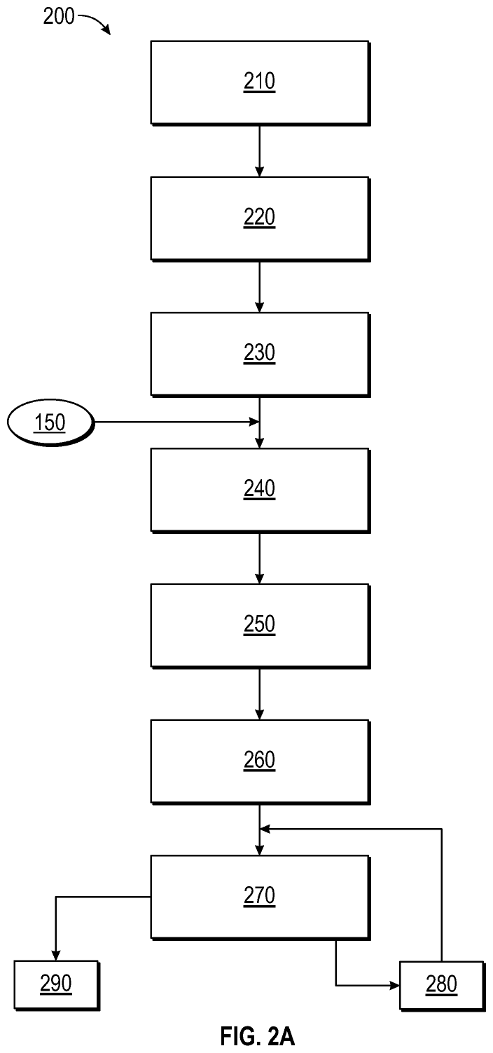

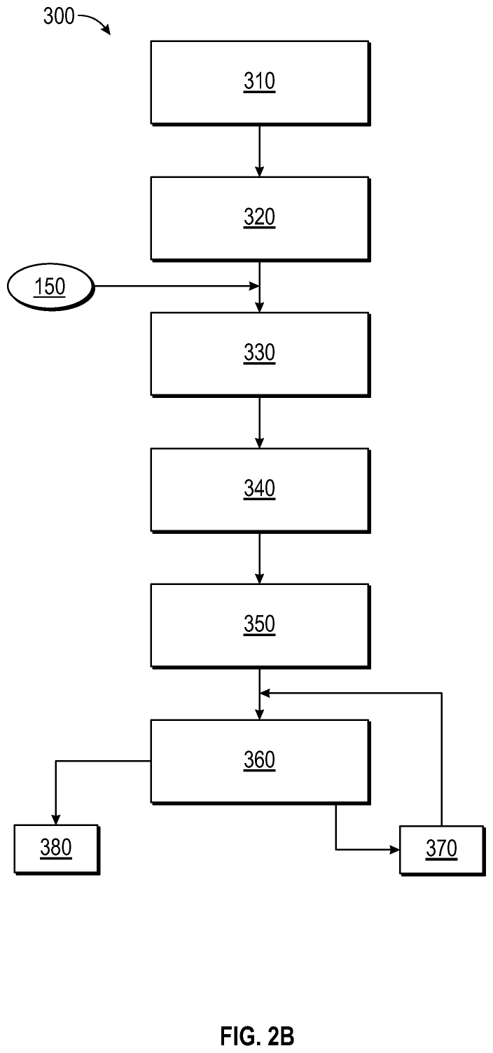

FIG. 2A is a flow diagram for an exemplary process 200 in accordance with an embodiment of the direct-run diatomite functional filler manufacturing methods of the present disclosure. In particular, manufacturing process 200 is suitable for making non-detectable crystalline silica functional filler products. Process 200 begins at step 210 with identifying and selecting an appropriate diatomite crude ore that meets the density and chemistry requirements, as described above. An appropriate diatomite crude ore is identified and selected based on the result of X-Ray Fluorescence (XRF) bulk chemistry of the alumina and iron oxide content of the ore. To identify a diatomite crude ore with the appropriate centrifuged wet density (CWD), a representative sample of the crude ore is dried and hammer-milled to pass 80 mesh size. This sample of the powder is then subjected to a CWD test to determine if the centrifuged wet density is less than about 0.32 g/l (about 20.0 lb/ft³). The standard operating procedures for carrying out the centrifuged wet density test and the XRF chemical analysis are described herein under the “Methods of Characterizing Direct-Run Diatomite Functional Filler Products” section of this disclosure, below. Again, the manufacturing process 200 is employed using diatomaceous earth ore with alumina content from about 3.0 and about 4.5 wt.-% and iron oxide content of from about 1.2 to about 2 wt.-%.

Next, the ore is subjected to a simultaneous process of milling and flash drying at step 220. This step may be carried-out in a single stage or in two stages, depending on the flash drying system employed. The feed moisture to the flash drying system may range from about 40 to about 60 wt.-%, and will typically drop down to less than about 5 wt.-% after drying. In the conventional diatomite process where filter aid is the main product and functional filler grades are by-products, the flash dryer system is operated to generate a coarser particle size distribution. Unlike the conventional process, effort is made during the flash drying step 220 to reduce the particle size of the dried material by increasing the milling of the feed, which tends to improve the efficiency of the final milling-classification process. A finer flash dried product also helps to improve the color of the flux-calcined product because the mass transfer of soda ash into the finer particles is much more efficient. The grinding media used in the milling may include ceramic alumina balls that may range in size from about 3 mm to about 50 mm, depending on the type of the media mill. Examples of media mills used in this embodiment are air-swept media mills, ball mills, and drum mills.

Thereafter, the dried powder from block 220 is subjected to dry heavy mineral impurities waste separation (benefication) in step 230 to remove quartz, chert, sand, and other heavy foreign matter in the ore through the use of an air separator or air classifier. Depending on the concentration of quartz and the manner it is disseminated in the ore, this separation step 230 may be capable of reducing the quartz content of the ore below the analytical detection limit and therefore provide for a final functional filler product that has non-detectable crystalline silica. The unit operation in step 230 is effective in removing heavy mineral impurities and does not significantly impact the overall bulk chemistry of the natural diatomaceous earth ore. Finely-milled soda ash powder is then pneumatically blended (step 150) into the beneficiated diatomaceous earth fine powder resulting from step 230 to maximize the distribution of the soda ash onto the surfaces of the diatomite particles. The amount of fluxing agent used for generating non-detectable cristobalite content flux-calcined kiln discharge product may range from about 2.0 wt.-% to about 6.0 wt.-%, such as from about 3.0 wt.-% to about 5.0 wt.-%.

Next, as one of the novel approaches in this disclosure, a step 240 is performed wherein the blended soda ash is solubilized in-situ to prepare the feed powder for calcination. In this step 240, the powder is fed into a continuous ribbon blender and about 5.0 wt.-% to about 15 wt.-% of atomized water is used to selectively solubilize the soda ash on the surface of the diatomite particles. The soluble soda ash provides a more efficient interaction with both small and large diatoms in comparison with the dry soda ash powder used in conventional manufacturing processes and results in better fluxing in the subsequent calcining operation.

As such, subsequent to the solubilization step 240, a calcination step 250 is performed wherein the calcination process conditions are selected such that the flux-calcined kiln discharge product results in a bright white color. Unlike the conventional processes where permeability of the discharge product is of essence, the calcination conditions in this embodiment are designed to provide minimal product agglomeration, which provides for a higher fines product yield needed for functional filler production and with no regard to product permeability. Higher fines yield from the kiln also allows for less milling of coarse particles, which in turn translates to a lower functional filler product density.

Another unique aspect of the calcination step 250 is the ability of the solubilized soda ash to provide for enhanced brightness of the kiln discharge even with the higher alumina and iron oxide chemistry of the feed ore at a lower calcination temperature. A combination of the lower calcination temperature, well-dispersed solubilized soda ash, and higher alumina and iron oxide chemistry are factors that provide for the non-detectable cristobalite content of the flux-calcined product.

In accordance with the foregoing aspects, the feed from step 240 may be calcined using a kiln temperature profile in the range of about 677° C. to about 1093° C. (about 1250° F. to about 2000° F.) for a time period ranging from about 20 minutes to about 40 minutes. For example, the feed may be calcined using a kiln temperature profile in the range of about 760° C. to about 1093° C. (about 1400° F. to about 2000° F.) for a time period ranging from about 15 minutes to about 30 minutes. The flux calcination step 250 may be carried out in a directly-fired kiln in which the feed makes direct contact with the flame from the kiln burner. The bright white color of the flux-calcined product may also be enhanced when the kiln atmosphere during calcination is under slightly reducing conditions, that is, with a stoichiometric ratio of air to fuel that results in incomplete combustion.

Subsequent to calcination, the process 200 continues at step 260 with the discharge from the rotary kiln being cooled and dispersed into fine powder by drawing ambient air into the system and pneumatically conveying the material into a collection cyclone and baghouse. Step 260 exhibits another unique aspect of this embodiment for the ease with which the flux-calcined product disperses in comparison to conventionally-made products with soda ash powder. Namely, the agglomerates generated in the kiln in the presence of the solubilized soda ash exhibit weak bonding, which provides for improved dispersion of the particles processed at step 260.

Then, at step 270, the fully dispersed material from step 260 is fed to an air classifier, which may be designed as top-feeding or bottom-feeding. Because color degradation is of concern in the production of functional filler products, all contact parts in the classification system may be ceramic-lined, for example made of a white alumina material. One variable used in the operation of the classifier is the classifying wheel speed, which may be increased for a finer product cut or decreased for a coarser product cut. The fines discharge from the air classifier is collected as the functional filler product (step 290) while the coarser fraction is charged back to a further milling process (step 280). At step 270, at least about 85 wt.-% of the flux-calcined material may be discharged as functional filler products, for example at least about 90 wt.-%.

Next, at step 280, the coarse fraction from the classification system is further milled. Prior to milling the coarse fraction from the classification system, the material may be taken through a separator to remove any heavy particles, such as glass from the calcination process or any chipped or worn out media from the mill. Here again, the grinding media used in the milling at step 280 may include ceramic alumina balls that may range in size from about 3 mm to about 50 mm, depending on the type of the media mill. Examples of media mills used in this embodiment are air-swept media mills, ball mills, and drum mills. The further milled powder resulting from step 280 is returned to the air classifier and is subjected to step 270 again.

A further unique aspect of the present embodiment for making direct-run functional filler products is related to the control of the centrifuged wet density (CWD), a considered property of filler products. There are at least two process variables that are used to control the densification of the product in the classification-milling circuit (i.e., steps 270 and 280). First, to minimize product densification, the media mill used in step 280 may be operated such that the particle size distribution from the mill discharge is similar to that of the fresh feed to the air classifier. Specifically, the D10 particle size may be similar to that of the fresh feed to the classifier. Second, a relatively higher degree of dispersion may be achieved at step 270 to provide for a much smaller re-circulating load in the classification-milling circuit (i.e., the coarse fraction), which in turn minimizes the contribution of densification from milling to the functional filler product. As such, as a result of process 200, an ND functional filler product is produced as the primary product, not as a by-product of filter aid production as has been conventional, having material properties as set forth above in Table 1.

Methods of Preparing Direct-Run Functional Filler Products with Detectable Crystalline Silica

In accordance with the second embodiment of the present disclosure, a method of preparing direct-run functional filler products with detectable crystalline silica (MW) is set forth below. In contrast with the first embodiment, the diatomaceous earth ore is selected to have a very low alumina and iron oxide content, which generally results in bright white color after flux-calcination. The alumina and iron oxide contents of these ores are in the range of less than about 3.0 and less than about 1.7 wt.-%, respectively, and these chemistries have the tendency to form cristobalite during the flux-calcination process. Many of these ores are used for the simultaneous production of both filter aids and functional fillers, so they tend to have low CWDs, which is useful in carrying-out direct-run milling operation. Table 4, below, provides some exemplary chemical and physical properties of ores that are suitable for use in accordance with this second embodiment.

TABLE 4
Exemplary Chemical and Physical Properties of
the Diatomite Ore Kiln Feed for the Production
of Fillers with Detectable Crystalline Silica

| CWD | CWD | SiO₂ | Al₂O₃ | Fe₂O₃ |
|---|---|---|---|---|
| (lb/ft³) | (g/ml) | (wt.-%) | (wt.-%) | (wt.-%) |
| 16.6 | 0.266 | 92.9 | 1.92 | 1.44 |
| 18.5 | 0.297 | 91.7 | 1.81 | 1.46 |
| 18.5 | 0.297 | 90.1 | 2.85 | 1.58 |
| 17.8 | 0.285 | 91.5 | 2.40 | 1.41 |
| 17.4 | 0.279 | 93.7 | 1.88 | 1.16 |
| 18.1 | 0.290 | 92.8 | 2.20 | 1.65 |

FIG. 2B illustrates a flow diagram for a process 300 for direct-run detectable crystalline silica diatomite functional filler manufacturing in accordance with the second embodiment of the present disclosure. Process 300 begins at step 310 with selecting an appropriate diatomite crude ore that meets the density and chemistry requirements, as set forth above. The diatomite crude ore is selected based on the result of X-Ray Fluorescence (XRF) bulk chemistry of the alumina and iron oxide content of the ore. To identify a diatomite crude ore with the appropriate centrifuged wet density (CWD), a representative sample of the crude ore is dried and hammer-milled to pass 80 mesh size. This sample of the powder is then subjected to a CWD test to determine if the centrifuged wet density is less than about 0.32 g/l (about 20.0 lb/ft³). Again, the standard operating procedures for carrying out the centrifuged wet density test and the XRF chemical analysis are described herein under the “Methods of Characterizing Direct-Run Diatomite Functional Filler Products” section of this disclosure, below.

Next, the ore is subjected to a simultaneous process of milling and flash drying at step 320. This step may be carried-out in a single stage or in two stages, depending on the flash drying system employed. The feed moisture to the flash drying system may range from about 40 to about 60 wt.-%, and will typically drop down to less than about 5 wt.-% after drying. In the conventional diatomite process where filter aid is the main product and functional filler grades are by-products, the flash dryer system is operated to generate a coarser particle size distribution. Unlike the conventional process, effort is made during the flash drying step 220 to reduce the particle size of the dried material by increasing the milling of the feed, which tends to improve the efficiency of the final milling-classification process. A finer flash dried product also helps to improve the color of the flux-calcined product because the mass transfer of soda ash into the finer particles is much more efficient. The grinding media used in the milling may include ceramic alumina balls that may range in size from about 3 mm to about 50 mm, depending on the type of the media mill. Examples of media mills used in this embodiment are air-swept media mills, ball mills, and drum mills.

Thereafter, the dried powder from block 320 is subjected to dry heavy mineral impurities waste separation (benefication) in step 330 to remove quartz, chert, sand, and other heavy foreign matter in the ore through the use of an air separator or air classifier. Depending on the concentration of quartz and the manner it is disseminated in the ore, this separation step 330 may be capable of reducing the quartz content of the ore below the analytical detection limit and therefore provide for a final functional filler product that has non-detectable crystalline silica. The unit operation in step 330 is effective in removing heavy mineral impurities and does not significantly impact the overall bulk chemistry of the natural diatomaceous earth ore. Finely-milled soda ash powder is then pneumatically blended (step 150) into the beneficiated diatomaceous earth fine powder resulting from step 330 to maximize the distribution of the soda ash onto the surfaces of the diatomite particles. The amount of fluxing agent used for generating non-detectable cristobalite content flux-calcined kiln discharge product may range from about 2.0 wt.-% to about 6.0 wt.-%, such as from about 3.0 wt.-% to about 5.0 wt.-%.

Next, subsequent to the benefication step 330, a calcination step 340 is performed wherein the calcination process conditions are selected such that the flux-calcined kiln discharge product results in a bright white color. Unlike the conventional processes where permeability of the discharge product is of essence, the calcination conditions in this embodiment are designed to provide minimal product agglomeration, which provides for a higher fines product yield needed for functional filler production and with no regard to product permeability. Higher fines yield from the kiln also allows for less milling of coarse particles, which in turn translates to a lower functional filler product density.

In accordance with the foregoing aspects, the feed from step 330 may be calcined using a kiln temperature profile in the range of about 760° C. to about 1177° C. (about 1400° F. to about 2150° F.) for a time period ranging from about 20 minutes to about 40 minutes. For example, the feed may be calcined using a kiln temperature profile in the range of about 820° C. to about 1093° C. (about 1510° F. to about 2000° F.) for a time period ranging from about 15 minutes to about 30 minutes. The flux calcination step 340 may be carried out in a directly-fired kiln in which the feed makes direct contact with the flame from the kiln burner. The bright white color of the flux-calcined product may also be enhanced when the kiln atmosphere during calcination is under slightly reducing conditions, that is, with a stoichiometric ratio of air to fuel that results in incomplete combustion.

Subsequent to calcination, the process 300 continues at step 350 with the discharge from the rotary kiln being cooled and dispersed into fine powder by drawing ambient air into the system and pneumatically conveying the material into a collection cyclone and baghouse. Step 350 exhibits another unique aspect of this embodiment for the ease with which the flux-calcined product disperses in comparison to conventionally-made products with soda ash powder. Namely, the agglomerates generated in the kiln in the presence of the solubilized soda ash exhibit weak bonding, which provides for improved dispersion of the particles processed at step 350.

Then, at step 360, the fully dispersed material from step 350 is fed to an air classifier, which may be designed as top-feeding or bottom-feeding. Because color degradation is of concern in the production of functional filler products, all contact parts in the classification system may be ceramic-lined, for example made of a white alumina material. One variable used in the operation of the classifier is the classifying wheel speed, which may be increased for a finer product cut or decreased for a coarser product cut. The fines discharge from the air classifier is collected as the functional filler product (step 380) while the coarser fraction is charged back to a further milling process (step 370). At step 360, at least about 85 wt.-% of the flux-calcined material may be discharged as functional filler products, for example at least about 90 wt.-%.

Next, at step 370, the coarse fraction from the classification system is further milled. Prior to milling the coarse fraction from the classification system, the material may be taken through a separator to remove any heavy particles, such as glass from the calcination process or any chipped or worn out media from the mill. Here again, the grinding media used in the milling at step 370 may include ceramic alumina balls that may range in size from about 3 mm to about 50 mm, depending on the type of the media mill. Examples of media mills used in this embodiment are air-swept media mills, ball mills, and drum mills. The further milled powder resulting from step 370 is returned to the air classifier and is subjected to step 360 again.

A further unique aspect of the present embodiment for making direct-run functional filler products is related to the control of the centrifuged wet density (CWD), a considered property of filler products. There are at least two process variables that are used to control the densification of the product in the classification-milling circuit (i.e., steps 360 and 370). First, to minimize product densification, the media mill used in step 370 may be operated such that the particle size distribution from the mill discharge is similar to that of the fresh feed to the air classifier. Specifically, the D10 particle size may be similar to that of the fresh feed to the classifier. Second, a relatively higher degree of dispersion may be achieved at step 360 to provide for a much smaller re-circulating load in the classification-milling circuit (i.e., the coarse fraction), which in turn minimizes the contribution of densification from milling to the functional filler product. As such, as a result of process 300, an MW functional filler product is produced as the primary product, not as a by-product of filter aid production as has been conventional, having material properties as set forth above in Table 2.

### Methods of Characterizing Direct-Run Diatomite Functional Filler Products

The methods of characterizing the direct-run diatomite functional filler products of the present disclosure are described in detail in the sections below.

Bulk Chemistry

Diatomaceous earth contains primarily the skeletal remains of diatoms and includes primarily silica, along with some minor amounts of impurities such as magnesium, calcium, sodium, aluminum, and iron. The percentages of the various elements may vary depending on the source of the diatomaceous earth deposit. The biogenic silica found in diatomaceous earth is in the form of hydrated amorphous silica minerals, which are generally considered to be a variety of opal with a variable amount of hydrated water. Other minor silica sources in diatomaceous earth may come from finely disseminated quartz, chert, and sand. These minor silica sources, however, do not have the intricate and porous structure of the biogenic diatom silica species.

The bulk chemistry of natural diatomaceous earth ores and products, in most cases, have an impact on the quality of the products made from the ores, and, in general, impacts the extractable metals properties and the cristobalite content of the flux-calcined filter aid product. XRF (X-ray fluorescence) spectroscopy is widely accepted as the analytical method of choice for determining the bulk chemistry of diatomaceous earth material, and it is a non-destructive analytical technique used to determine the elemental composition of materials. XRF analyzers determine the chemistry of a sample by producing a set of characteristic fluorescent X-rays that is unique for that specific element, which is why XRF spectroscopy is an excellent technology for qualitative and quantitative analysis of material composition. In the testing of the bulk chemistry of the direct-run diatomite functional filler products reported herein, 5 g dried powdered sample together with 1 g of X-ray mix powder binder are finely milled in a Spex® mill and then pressed into a pellet. The pellet is loaded into an automated Wavelength Dispersive (WD) XRF equipment, which has been previously calibrated with diatomaceous earth reference averages, to determine the bulk chemistry. To accommodate the natural loss of hydration within the silica structure, the total mineral contents for all the examples are reported on the Loss-on-Ignition (LOI) or on ignited basis for their respective high oxides. As used herein, “on ignited basis” means the mineral oxide content measured without the influence of the water of hydration within the silica structure.

Centrifuged Wet Density

The wet density of a natural diatomaceous earth ore or product is a measure of the void volume available for capturing particulate matter during a filtration process. Wet densities are often correlated with unit consumption of diatomite filtration media. In other words, a diatomite filtration media possessing a low centrifuged wet density often provides for low unit consumption of the diatomite product in filtration operations.

Several methods have been used to characterize the wet density of diatomite functional filler products. The method used in the present disclosure is the centrifuged wet density (CWD) and/or wet bulk density (WBD) as described under the Permeability test method, below. This CWD test method is known in the prior art, such as in U.S. Pat. Nos. 6,464,770; 5,656,568; and 6,653,255. In this test method, 10 ml of deionized water is first added to a 15 ml graduated centrifuge glass tube and 1 g of dry powder sample is loaded into the tube. The sample is completely dispersed in the water using a vortex-genie 2 shaker. A few milliliters of deionized water is then used to rinse the sides of the tube to ensure all particles are in suspension and the contents brought up to the 15 milliliters mark. The tube may then be centrifuged for 5 min at 2680 rpm on an IEC Centra® MP-4R centrifuge, equipped with a Model 221 swinging bucket rotor (International Equipment Company; Needham Heights, Mass., USA). Following centrifugation, the tube may be carefully removed without disturbing the solids, and the level (i.e., volume) of the settled matter may be noted by reading off at the graduated mark, measured in cm³. The centrifuged wet density of powder may be readily calculated by dividing the sample mass by the measured volume. The centrifuge wet density is determined as weight of the sample divided by the volume in g/ml. A conversion factor of 62.428 is applied to obtain the centrifuged wet density in lb/ft³. The WBD of the diatomaceous earth products described herein may range from about 13 lb/ft³ to about 22 lb/ft³, or from about 15 lb/ft³ to about 20 lb/ft³.

Optical Properties

The optical properties of the direct-run diatomite functional filler products are characterized by using the color space defined by the Commission Internationale de I'Eclairage (CIE), as the L*a*b* color space. The L* coordinate represents brightness and is a measure of reflected light intensity (0 to 100), the a* coordinate represents values showing color variation between green (negative value) and red (positive value), whereas the b* coordinate represents values showing color variation between blue (negative value) and yellow (positive value). A Konica Minolta® Chroma-meter CR-400 is used to measure the optical properties of samples described herein.

A dry representative sample (approximately 2 g or enough to cover the measuring tip of the meter) is taken and ground using a mortar and pestle. The resulting ground powder is spread on white paper and pressed with a flat surface to form a packed smooth powder surface. The Chroma Meter is pressed on the powder and the readings were noted.

Particle Size

Particle size may be measured by any appropriate measurement technique now known to the skilled artisan or those described herein. For example, particle size and particle size properties, such as particle size distribution (“PSD”), are measured using a Microtrac S3500 laser particle size analyzer (Microtrac, Inc, Montgomeryville, Pa., USA), which can determine particle size distribution over a particle size range from about 0.12 μm to about 704 μm. Briefly, in the test, a small amount of the sample (a pinch of the sample) is placed in the sample cell in the Microtrac analyzer, followed by gentle ultrasonication for 10 seconds to disperse the particles. A laser is incident on the particles and the scattered light from the particles is collected on a detector. The scattering intensities are analyzed using auto-correlator function and the translational diffusion coefficient is determined. The diffusion coefficient is then used to determine the particle size which is reported on volume basis. The size of a given particle is expressed in terms of the diameter of a sphere of equivalent diameter, also known as an equivalent spherical diameter or “ESD.” The median particle size, or d₅₀ value, is the value at which 50% by weight of the particles have an ESD less than that d₅₀ value. The d₁₀ value is the value at which 10% by weight of the particles have an ESD less than that d₁₀ value. Likewise, the d₉₀ value is the value at which 90% by weight of the particles have an ESD less than that d₉₀ value.

Hegman Gauge

The Hegman gauge and associated test method provide a measure of the degree of dispersion or fineness of grind of a functional additive powder in a pigment-vehicle system. It is used to determine if a functional additive is of an appropriate size to embody the finished film (paint or plastic) with desired surface smoothness and other properties. Hegman values range from 0 (coarse particles) to 8 (extremely fine particles) and are related to the coarser end of the particle size distribution of the sampled powder. The Hegman gauge and test method are described in detail in American Society of Testing and Materials (ASTM) method D1210. The gauge itself is a polished steel bar into which a very shallow channel of decreasing depth is machined. The channel is marked on its edge with gradations corresponding to Hegman values (0 to 8). The powder sample is dispersed within a liquid vehicle (paint, oil, etc.), and a small quantity of the suspension is poured across the deep end of the channel. A scraper is then used to draw the suspension toward the shallow end of the channel. The channel of the gauge is then visually inspected in reflected light, and the point at which the suspension first shows a speckled pattern corresponds with the Hegman value.

Quantification of Cristobalite

Thermal processing of the natural diatomaceous earth ore to generate higher permeability flux-calcined products with brighter white color results in sintering and agglomeration of the particles with the effect of dehydrating the opaline structure of the products. Opal-A phase, which is the most common form of opal in natural, unprocessed diatomaceous earth, can convert to Opal-CT and/or Opal-C during the thermal treatment, and if subjected to further heat or higher temperatures, to the cristobalite mineral phase. Under some conditions, the Opal phases can convert to quartz and cristobalite, crystalline forms of silica that do not contain any hydrated water. It is to be noted that the intricate and porous structure of the diatomaceous earth can be maintained in products that contain crystalline forms of silicon dioxide, but such products may also contain some unstructured, melted silicon dioxide in the form of crystalline silica.

Two separate test methods were used in this disclosure to determine whether a sample of diatomite product contains cristobalite. The test methods used are based on the OSHA method that uses X-Ray Diffraction (XRD) as well as the use of Differential Scanning calorimetry. These test methods are described in the following sections, below.

OSHA ID-142 Version 4.0 for Quartz and Cristobalite Determination

OSHA ID-142 is a published protocol primarily used for determining respirable crystalline silica in occupational environments. It is based on the NIOSH 7500 method and was most recently updated in May 2016. The protocol is geared toward analysis of air cyclone-collected respirable dust samples via x-ray diffraction (XRD), and includes explicit and detailed instructions regarding sampling procedure, sample preparation, analysis, interferences, calculations, and method validation. Dust samples are collected on PVC membranes and accurately weighed to determine the total respirable dust quantity. The membranes are subsequently dissolved in a solvent and the suspended dust re-deposited on a silver membrane in a very thin layer for XRD analysis. The total mass of dust per sample that can be analyzed is limited by this factor to approximately 2 mg. The method can also be used on bulk samples (finely milled, deposited on silver membranes, and limited to 2 mg aliquots). The diffraction patterns are examined for peaks associated with quartz and cristobalite. If these are found to be present, the phases are quantified by comparing peak net intensities with external calibration standards. The reliable quantification limits (RQL) are about 0.5% for quartz (9.8 μg/sample) and 1.0% for cristobalite (20.6 μg/sample), with detection limits at slightly less than half those levels.

The OSHA method specifies acceptable ranges for diffraction peak locations related to the crystalline silica polymorphs (peaks must be within 0.05° 2° of expected for both cristobalite and quartz). In addition, secondary and tertiary peaks must be positively identified and with net intensities greater than the established detection limits of the overall procedure (DLOP) for each peak (as listed in section 4.1 of the method). If these conditions are not met for cristobalite and/or quartz, then the presence of cristobalite and/or quartz is not reported (ND).

While the OSHA protocol does not specifically address the opal-C phase, use of the method on bulk samples of diatomaceous earth products will result in a de facto differentiation of opal-C from cristobalite. Products including opal-C will be reported as not containing cristobalite, while those including cristobalite will be reported as such (if the quantity of cristobalite is greater than 1.0% of the total sample mass).

Procedure Summary

(1) Standards: A standard curve is prepared for both cristobalite and quartz by adding different masses of NIST cristobalite and quartz standards (1879b and 1878a) to Spex-milled natural diatomaceous earth aliquots (from 10 to 200 μg of each standard into 2.000 mg DE samples). Each spiked sample is re-weighed on a PVC membrane, then digested and blended in tetrahydrofuran (THF) and re-deposited on a silver membrane as specified in ID-142, section 3.3. The stabilized standards on silver membranes are analyzed using XRD, and standard curves are established for primary and secondary diffraction peaks (comparing net intensity in counts per second with standard mass and concentration).

(2) Samples: Approximately 1 g of dry representative sample is placed in a Spex Mill (Zirconia cylinder and ball) and milled for 10 minutes. From this milled sample, between 1.500 and 2.000 mg is placed on a pre-weighed PVC membrane, then digested and blended in tetrahydrofuran (THF) and re-deposited on a silver membrane as specified in ID-142, section 3.4.2. The stabilized samples mounted on the silver membranes are analyzed using XRD. 2θ ranges scanned include 20.0°-22.5°, 25.5°-27.2°, 30.7°-32.1°, and 37.0°-39.0° (silver peak).

(3) Analysis: The scanned diffraction pattern is adjusted as needed so that the primary silver peak is centered at 38.114° 2θ. Then the scan is examined to see if primary and secondary quartz and cristobalite peaks are present in the defined 20 ranges as shown in Table 5, below. If so, the net intensities of all peaks are determined using the software, and quantities of cristobalite and quartz are calculated based on the established standard curves. If the peak net intensities result in estimated phase contents less than the RQL for either phase (0.5% for quartz, 1.0% for cristobalite), then the specific phase is reported as detected but not quantified. If peaks are not present in the defined 2θ ranges for either quartz or cristobalite, then the specific phase (quartz or cristobalite) is reported as not detected.

TABLE 5
Quartz and Cristobalite XRD Peak Ranges
(based on ID-142 Table 3.5.1.1)

| | Minimum | Maximum |
|---|---|---|
| Diffraction Peak | Acceptable 2θ | Acceptable 2θ |
| Quartz Primary | 26.61 | 26.71 |
| Quartz Secondary | 20.83 | 20.93 |
| Cristobalite Primary | 21.95 | 22.05 |
| Cristobalite Secondary | 31.37 | 31.47 |

All of the XRD work detailed herein is performed using a Siemens® D5000 diffractometer controlled with MDI™ Datascan5 software, with CuKα radiation, sample spinning, graphite monochromator, and scintillation detector. Power settings are at 50 KV and 36 mA, with step size at 0.02° and 6 seconds per step (0.02° and 1 second per step for silver peak). JADE™ (2010) software is used for analyses of XRD scans.

Confirmation of Presence of Cristobalite by Differential Scanning Calorimetry

Differential Scanning calorimetry (DSC) analysis is used to study the behavior of materials as a function of temperature or time by measuring the heat flow produced in a sample when it is heated, cooled, or held isothermally at constant temperature. The DSC technique can measure the amount of heat absorbed or released during such transitions, and it may be used to observe more subtle physical changes, such as glass transitions.

It has been established that cristobalite undergoes a reversible, displacive phase transformation from α (low) to β (high) cristobalite in the range of 200° C. to 300° C. Testing conducted in this work showed that the transition temperature for cristobalite derived from DE seems to be significantly lower than that for cristobalite derived from quartz (175-210° C. versus 240-270° C.), possibly due to the significant non-siliceous components associated with diatomaceous earth in comparison to the relatively pure silica of quartz. Data collected during this work also suggest that opal-C phase does undergo a minor, reversible phase change at significantly lower temperature than seen with cristobalite below about 170° C. This “phase change” is possibly an indication of a glass transition temperature.

There are situations where DSC results show two reversible phase changes (with the higher temperature change at or above 200° C.) that may indicate that some (impure) cristobalite exists in the product where XRD results might not indicate that is the case. Thus, DSC can be a useful tool where initial XRD testing does not provide a conclusive answer as to whether a sample includes cristobalite.

In the DSC test, sample preparation includes encapsulating small aliquots of dried, finely divided diatomaceous earth in covered, 40 μl aluminum pans. Pans and covers are handled with tweezers and/or a suction manipulator. Each aluminum pan is tared using a microbalance, and the sample of diatomaceous earth is placed in the pan and weighed. Diatomaceous earth sample size typically varies between 5.000 mg and 13.000 mg. Once the sample has been placed in the pan and weighed, an aluminum cover plate is placed on top of the sample. The assembly is placed in a die and sealed using a Perkin Elmer Universal Crimper Press. The encapsulated sample is placed in a sealed test tube to prevent external contamination until the DSC testing is performed.

A Perkin-Elmer DSC 4000 instrument with Intracooler II is used for the DSC scans. It is capable of analyzing over a temperature range of from −70° C. to 450° C. The DSC 4000 is calibrated quarterly using zinc and indium reference materials provided through Perkin-Elmer.

After inputting mass and identification data, each encapsulated sample is analyzed using the following instrument parameters:

(1) Heat to 100° C. and hold for 1 minute.
(2) Heat from 100° C. to 300° C. at a rate of 10.00° C. per minute.
(3) Cool from 300° C. to 95° C. at a rate of 10.00° C. per minute.
Data were collected and analyzed using Perkin-Elmer PYRIS software.

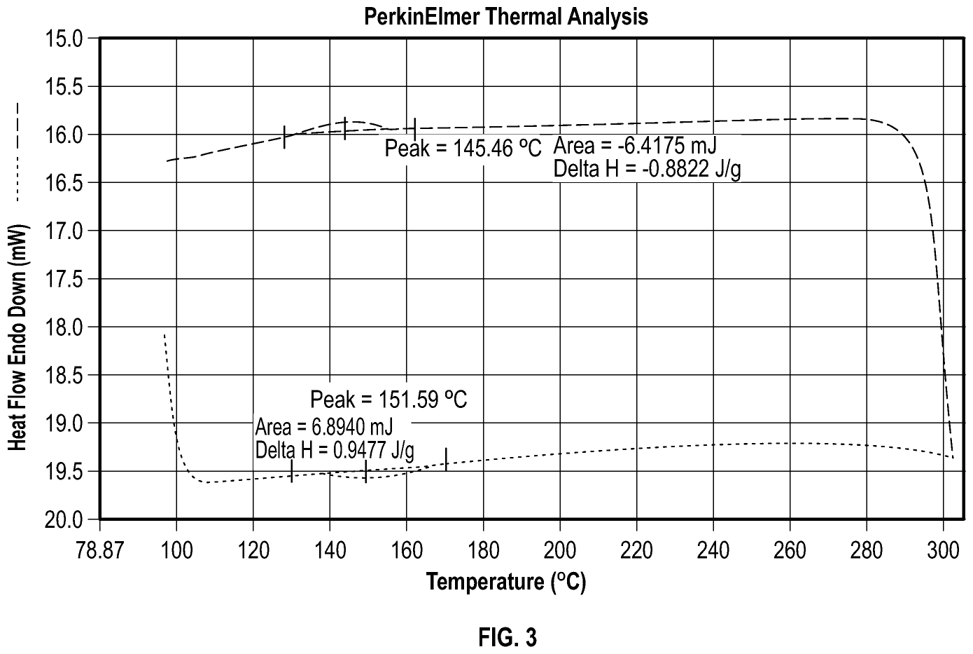

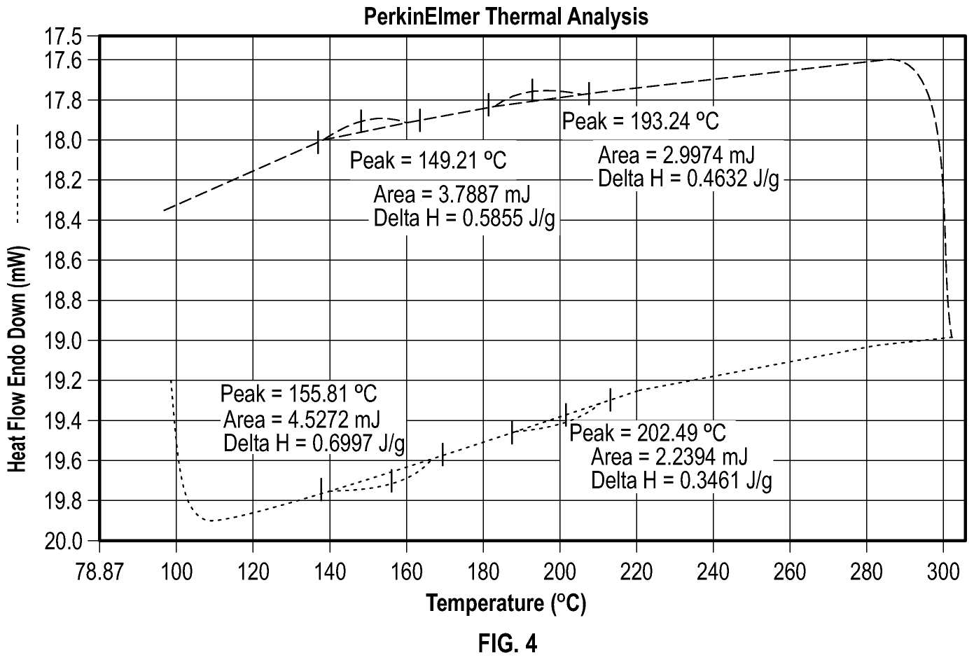

Interpretation of Results: Pure cristobalite (>99% SiO₂) undergoes a reversible phase transformation as indicated on DSC thermograms at between 240° C. and 270° C. during the heating phase, with the transition at slightly lower temperature during the cooling phase. Impure cristobalite (95% to 99% SiO₂), as is often found in samples of flux-calcined diatomaceous earth, undergoes the α to β phase transformation at between 195° C. and 220° C. (heating phase). Samples including opal-C show a phase transition at between 140° C. and 175° C. during heating. FIG. 3 gives a Differential Scanning calorimetry (DSC) plot showing the presence of opal-C with a phase transition at between 140° C. and 175° C. during heating with no peak for cristobalite. Differentiation of cristobalite and opal-C is difficult when transitions are shown at temperatures between 175° C. and 195° C. In addition, DSC thermograms that show two reversible phase transitions indicate the existence of both opal-C phase and cristobalite within the same sample, something not always apparent based on XRD results, as illustrated in FIG. 4.

### ILLUSTRATIVE EXAMPLES

The various embodiments of the present disclosure are now illustrated by the following non-limiting examples. It should be noted that various changes and modifications can be applied to the following examples and processes without departing from the scope of this invention, which is defined in the appended claims. Therefore, it should be noted that the following examples should be interpreted as illustrative only and not limiting in any sense.

Various product examples of the direct-run functional filler diatomite products with non-detectable crystalline silica content of the present disclosure are given below, showing filler products covering Hegman ranges of 1.0 to 3.0. Also shown in these examples are MW diatomite functional filler products also using the direct-run process. These examples are offered by way of illustration and not by way of limitation.

Direct-Run Diatomite Functional Filler Products with Non-Detectable Crystalline Silica Content

Natural diatomaceous earth crude ore was identified and mined from the ore deposit to form a stockpile. A composite sample from the stockpile was dried and hammer-milled to pass 80 mesh size. A sample of the milled powder was then analyzed using the XRF test method to determine the bulk chemistry of the ore and to ensure that the bulk chemistry of alumina and iron oxide were in the desired range. The quartz content of the natural ore sample was also analyzed using XRD test method. The standard operating procedure for the analysis of the bulk chemical composition and quartz content of the sample are described herein under the “Methods of Characterizing Direct-Run Diatomite Functional Filler Products” section of this disclosure, above.

The bulk chemistry of the natural feed ores used in preparing the direct-run diatomite functional filler products with non-detectable crystalline silica content in the examples ranged from 3.0 wt.-% to 4.5 wt.-% for aluminum oxide and 1.2 wt.-% to 2.0 wt.-% for iron oxide. The quartz content in the feed material was found to be below the detection limit (ND) of the analysis.

Based on the composite sample analysis, about 100 dry tons of the stockpile was processed through the diatomite processing plant following the manufacturing process 200 of FIG. 2A, starting at block 210 and continuing to block 270, to obtain a flux-calcined diatomite dispersed powder. The powder was then used as feed for the classification-milling process that follows the circuit in blocks 270 and block 280 of the manufacturing process 200 to make different grades of filler products. The process conditions and the natural feed ore composition for the rotary kiln calcination is given in Table 6 below. The particle size distribution of the cooled and dispersed flux-calcined diatomite powder is also shown.

TABLE 6
Process Conditions for the Rotary Kiln Calcination of Exemplary Direct-Run Diatomite
Functional Filler Products with Non-Detectable Crystalline Silica Content

| Feed Ore | Feed Ore | | | | | | |
|---|---|---|---|---|---|---|---|
| Chemistry | Chemistry | | | | | | |
| (Component) | (Wt.-%) | Kiln Temperature | | Dispersed Product Particle Size (μm) | | | |
| Al₂O₃ | 4.1 | Feed | Discharge | D₅ | D₁₀ | D₅₀ | D₉₅ |
| | | End | End | | | | |
| Fe₂O₃ | 1.5 | 680° C. | 1040° C. | 11.3 | 14.7 | 41.8 | 144.6 |

Direct-Run Diatomite Functional Filler Products with Detectable Crystalline Silica Content

Natural diatomaceous earth crude ore was identified and mined from the ore deposit to form a stockpile. Composite sample from the stockpile was dried and hammer-milled to pass 80 mesh size. A sample of the milled powder was then analyzed using the XRF test method to determine the bulk chemistry of the ore and to ensure that the bulk chemistry of alumina and iron oxide were in the desired range. Unlike the non-detectable crystalline silica content filler grades processing, the quartz content of the natural ore sample is not a critical requirement to the property of the product because cristobalite is formed in almost all cases during the calcination of this high grade ore. The standard operating procedure for the analysis of the bulk chemical composition of the sample are described herein under the “Methods of Characterizing Direct-Run Diatomite Functional Filler Products” section of this disclosure, above.

The bulk chemistry of the natural feed ores used in preparing the direct-run diatomite functional filler products with detectable crystalline silica content in this disclosure had less than 3.0 wt.-% alumina and less than 1.7 wt.-% iron oxide.

Based on the composite sample analysis, about 100 dry tons of the stockpile was processed through the diatomite processing plant following the manufacturing process 300 of FIG. 2B, starting at block 310 and continuing to block 360, to obtain a flux-calcined diatomite dispersed powder. The powder was then used as feed for the classification-milling process that follows the circuit in blocks 360 and block 370 of the manufacturing process 300 to make different grades of filler products. The process conditions and the natural feed ore composition for the rotary kiln calcination is given in Table 7, below. The particle size distribution of the cooled and dispersed flux-calcined diatomite powder is also shown therein.

TABLE 7
Process Condition for the Rotary Kiln Calcination of Exemplary Direct-Run Diatomite
Functional Filler Products with Detectable Crystalline Silica Content

| Feed Ore | Feed Ore | | | | | | |
|---|---|---|---|---|---|---|---|
| Chemistry | Chemistry | | | | | | |
| (Component) | (Wt.-%) | Kiln Temperature | | Dispersed Product Particle Size (μm) | | | |
| Al₂O₃ | 2.7 | Feed | Discharge | D₅ | D₁₀ | D₅₀ | D₉₅ |
| | | End | End | | | | |
| Fe₂O₃ | 1.4 | 720° C. | 1100° C. | 11.1 | 13.8 | 31.5 | 105.2 |

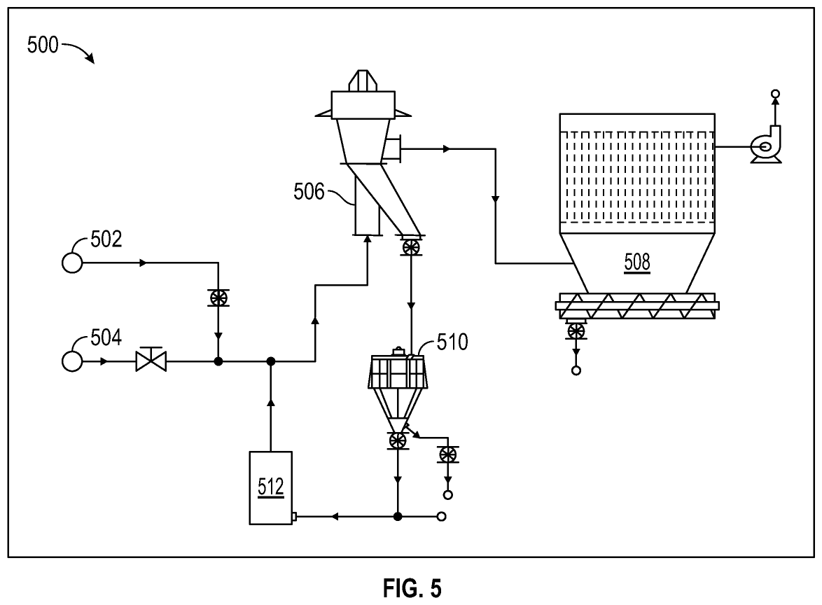

A pilot scale classification-milling system 500 as illustrated in FIG. 5 was utilized in making the functional filler grades. System 500 generally includes a feed bin 502 containing the raw material and a classifier air inlet 504 that brings classifier air to the feed. In the examples, the milling was carried out by utilizing an air-swept media mill 512, which was coupled to an air-classifier 506. The classifier fines product was collected into a baghouse 508 as the filler product and the classifier coarse discharge was fed into a mechanical air separator 510. The installation of the mechanical air separator 510 served two purposes, namely to remove very small worn out media that eventually exits the media mill and also to reject heavy glassy particles that were generated during the calcination process. Purging the system of these unwanted materials helped to minimize product densification that would occur over time due to accumulation from the circulating load. This system 500 was used for both the non-detectable and detectable crystalline silica products manufacturing. The feed and air are processed in a high-efficiency air classifier 506, which outputs fines product to a baghouse 508 and the by

### Example 1

The properties of exemplary direct-run functional filler products having a Hegman of 1.0 with one grade having non-detectable crystalline silica and the other grade having crystalline silica in the form of cristobalite are provided in Table 8, below. The non-detectable filler grade was made with a higher alumina and iron oxide ore while the detectable grade was made with diatomaceous earth ore with very low alumina and iron oxide content. With the lower impurity ore, the corresponding flux-calcined product color is much brighter but also generates cristobalite. The color difference between the non-detectable and detectable crystalline silica grades is depicted by the Y and b* color value.

TABLE 8
Physical and Chemical Properties of Direct-
Run Hegman 1.0 Value Filler Products

| | Direct-Run Non-Detectable | | Direct-Run Detectable | |
|---|---|---|---|---|
| | Crystalline Silica Filler Products | | Crystalline Silica Filler Products | |
| Run Samples | Run 1A | Run 1B | Run 2A | Run 2B |
| Hegman | 1.0 | 1.0 | 1.0 | 1.0 |
| Filler Yield (%) | 95 | 97 | 95 | 95 |
| Y | 89.6 | 85.1 | 92.1 | 94.6 |
| L* | 95.8 | 93.5 | 96.9 | 97.1 |
| a* | 0.34 | 0.29 | −0.04 | 0.02 |
| b* | 2.25 | 2.15 | 1.58 | 1.88 |
| GCOA (%) | 145 | 140 | 138 | 132 |
| D10 (μm) | 11.7 | 12.0 | 12.1 | 12.5 |
| D50 (μm) | 27.3 | 28.8 | 28.8 | 27.5 |
| D90 (μm) | 49.9 | 50.7 | 51.9 | 52.6 |
| D95 (μm) | 58.3 | 61.8 | 64.7 | 61.8 |
| CWD (lb/ft³) | 18.7 | 23.5 | 19.5 | 21.8 |
| +325 Mesh Fraction | 3.6 | 3.8 | 3.9 | 3.6 |
| Hegman | 1.0 | 1.0 | 1.0 | 1.0 |
| Flatting Efficiency | 0.5 | 0.5 | 0.5 | 0.5 |
| % Al₂O₃ | 4.4 | 3.1 | 2.2 | 2.9 |
| % Fe₂O₃ | 1.8 | 1.4 | 1.2 | 1.4 |
| % Cristobalite | ND | ND | 15.2 | 20.1 |
| % Quartz | ND | ND | ND | ND |

ND: Non-Detectable (below detection limit)

Unlike the conventionally made diatomite functional filler products which are less than 30 wt.-% of the functional filler and made as by-products, the product yield for these direct-run fillers are almost 100%. Losses in making these direct-run filler products came from the removal of heavy particles at the separator stage. The use of a high efficiency classifier in the milling-classification circuit provides for a sharp D95 size cut, which results in a high flatting efficiency in comparison to current available commercial products.

### Example 2

Table 9, below, shows the properties of exemplary non-detectable and detectable crystalline silica diatomite functional filler products of the present examples that have been classified and milled to make Hegman 2.0 value products by increasing the degree of milling and cutting the particle size much finer. Finer particle size was achieved by increasing the speed of the classifier and achieving product Hegman value of about 2.0. In general, the product density is higher in comparison to Hegman 1.0 value products due to the finer particle size distribution. The properties of these products are the same as products made as a byproduct by the traditional process.

TABLE 9
Physical and Chemical Properties of Direct-
Run Hegman 2.0 Value Filler Products

| | Direct-Run Non-Detectable | | Direct-Run Detectable | |
|---|---|---|---|---|
| | Crystalline Silica Filler Product | | Crystalline Silica Filler Products | |
| Run Sample | Run 3A | Run 3B | Run 4A | Run 4B |
| Product Hegman | 2.0 | 2.0 | 2.0 | 2.5 |
| Filler Yield (%) | 95 | 89 | 94 | 97 |
| Y | 85.9 | 89.8 | 96.7 | 92.9 |
| L* | 96.1 | 95.5 | 97.1 | 97.0 |
| a* | 0.60 | −0.10 | −0.07 | −0.14 |
| b* | 2.60 | 2.45 | 1.44 | 1.93 |
| GCOA (%) | 121 | 120 | 127 | 121 |
| D10 (μm) | 8.3 | 7.9 | 8.4 | 7.6 |
| D50 (μm) | 17.4 | 18.4 | 18.3 | 17.4 |
| D90 (μm) | 36.2 | 39.8 | 38.6 | 36.2 |
| D95 (μm) | 41.8 | 44.3 | 48.2 | 35.8 |
| CWD (lb/ft³) | 27.9 | 23.5 | 23.8 | 22.4 |
| +325 Mesh Fraction | 1.1 | 1.9 | 1.20 | 0.70 |
| Flatting Efficiency | 0.8 | 0.7 | 0.7 | 0.8 |
| % Al₂O₃ | 4.5 | 3.3 | 1.7 | 2.9 |
| % Fe₂O₃ | 1.5 | 1.4 | 1.2 | 1.5 |
| % Cristobalite | ND | ND | 18.3 | 19.9 |
| % Quartz | ND | ND | ND | ND |

### Example 3

Exemplary diatomite functional filler products of runs 5A, 5B, and 6A, 6B of the present disclosure are shown in Table 10, below. These were filler products that were in the Hegman 4.0 value fineness. Run products 5A and 5B represent products that showed ND properties for crystalline silica and as expected, while those from runs 6A and 6B showed products with crystalline silica, mainly from the presence of cristobalite because quartz was absent in the diatomaceous earth ore that was used for the development. The yield from these direct-run filler production processes was significantly higher than any conventionally-made diatomite product with a Hegman value of 4.0. In practice, the Hegman 4.0 value diatomite filler products are the most difficult to manufacture and the best yields are only around 10 wt.-%, due to the fineness of cut.

TABLE 10
Physical and Chemical Properties of Direct-
Run Hegman 4.0 Value Filler Products

| | Direct-Run Non-Detectable | | Direct-Run Detectable | |
|---|---|---|---|---|
| | Crystalline Silica Filler Product | | Crystalline Silica Filler Products | |
| Run Sample | Run 5A | Run 5B | Run 6A | Run 6B |
| Product Hegman | 3.5 | 4.0 | 4.0 | 4.0 |
| Filler Yield (%) | 85 | 94 | 91 | 92 |
| Y | 85.1 | 90.0 | 93.9 | 96.9 |
| L* | 94.1 | 94.5 | 96.6 | 96.0 |
| a* | 0.50 | −0.10 | −0.05 | −0.12 |
| b* | 2.45 | 2.54 | 1.40 | 1.53 |
| GCOA (%) | 111 | 108 | 107 | 101 |
| D10 (μm) | 6.2 | 6.9 | 7.4 | 7.6 |
| D50 (μm) | 12.0 | 14.4 | 14.3 | 17.4 |
| D90 (μm) | 23.1 | 29.8 | 28.6 | 26.2 |
| D95 (μm) | 25.9 | 31.3 | 37.2 | 35.8 |
| CWD (lb/ft³) | 27.9 | 25.5 | 23.8 | 26.0 |
| +325 Mesh Fraction | trace | trace | trace | trace |
| Flatting Efficiency | 1.0 | 1.0 | 0.9 | 0.9 |
| % Al₂O₃ | 4.5 | 3.3 | 1.7 | 2.9 |
| % Fe₂O₃ | 1.9 | 1.3 | 1.2 | 1.5 |
| % Cristobalite | ND | ND | 18.3 | 19.9 |
| % Quartz | ND | ND | ND | ND |

Accordingly, the present disclosure has provided various embodiments of processes for manufacturing direct-run white flux-calcined diatomaceous earth functional filler products. In particular, in a first embodiment, the present disclosure has provided processes for manufacturing functional filler products containing diatomaceous earth, the diatomaceous earth derived from ores that have been specifically selected for their natural alumina and iron oxide contents and then processed with feed preparation and thermal treatment methods that tend to suppress the mechanism that triggers the generation of cristobalite in the presence of soda flux during calcination. The present disclosure also has provided, in a second embodiment, direct-run functional filler products containing diatomaceous earth, the diatomaceous earth products containing crystalline silica in the form of quartz or cristobalite that is produced following alternative methods of feed preparation and calcination.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the invention as set forth in the appended claims.

In this document, relational terms such as first and second, and the like may be used solely to distinguish one entity or action from another entity or action without necessarily requiring or implying any actual such relationship or order between such entities or actions. Numerical ordinals such as “first,” “second,” “third,” etc. simply denote different singles of a plurality and do not imply any order or sequence unless specifically defined by the claim language. The sequence of the text in any of the claims does not imply that process steps must be performed in a temporal or logical order according to such sequence unless it is specifically defined by the language of the claim. The process steps may be interchanged in any order without departing from the scope of the invention as long as such an interchange does not contradict the claim language and is not logically nonsensical.

What is claimed is:

1. A method for manufacturing a diatomaceous earth functional filler product comprising the steps of:
selecting a diatomaceous earth ore;
simultaneously milling and flash-drying the diatomaceous earth ore;
beneficiating the milled and flash-dried diatomaceous earth ore;
blending the beneficiated diatomaceous earth ore with a fluxing agent;
calcining the blended diatomaceous earth ore and the fluxing agent to produce an initial diatomaceous earth powder;
air-classifying the initial diatomaceous earth powder to produce a first fraction comprising the diatomaceous earth functional filler product and a second fraction comprising coarse particles;
further milling the coarse particles to produce additional diatomaceous earth powder; and
re-circulating the additional diatomaceous earth powder to blend the additional diatomaceous earth powder with the initial diatomaceous earth powder.

2. The method of claim 1, wherein selecting the diatomaceous earth ore comprises selecting a diatomaceous earth ore with alumina content from about 3.0 and about 4.5 wt.-% and iron oxide content of from about 1.2 to about 2 wt.-%.

3. The method of claim 1, wherein selecting the diatomaceous earth ore comprises selecting a diatomaceous earth ore with alumina content of less than about 3.0 wt.-% and iron oxide content of less than about 1.7 wt.-%.

4. The method of claim 1, wherein selecting the diatomaceous earth ore comprises selecting a diatomaceous earth ore with a centrifuged wet density of less than about 0.32 g/l (about 20.0 lb/ft³).

5. The method of claim 1, further comprising solubilizing the fluxing agent with atomized water subsequent to the blending.

6. The method of claim 5, further comprising solubilizing the fluxing agent with atomized water prior to the calcining.

7. The method of claim 6, wherein solubilizing the fluxing agent comprises solubilizing the fluxing agent with about 5.0 wt.-% to about 15 wt.-% of the atomized water, wherein the wt.-% of the atomized water is on the basis of the blended diatomaceous earth ore and the fluxing agent.

8. The method of claim 1, wherein the calcining is performed at a temperature of about 677° C. to about 1093° C. (about 1250° F. to about 2000° F.) for a time period ranging from about 20 minutes to about 40 minutes.

9. The method of claim 1, wherein the calcining is performed at a temperature of about 760° C. to about 1177° C. (about 1400° F. to about 2150° F.) for a time period ranging from about 20 minutes to about 40 minutes.

10. The method of claim 1, wherein the air-classifying comprises air-classifying to produce a first fraction comprising a diatomaceous earth functional filler product having a Hegman gauge value of from about 1.0 to about 4.0.

11. The method of claim 1, wherein the step of blending the beneficiated diatomaceous earth ore with the fluxing agent comprises blending the beneficiated diatomaceous earth ore with soda ash.

12. A method for manufacturing a diatomaceous earth functional filler product having non-detectable crystalline silica comprising the steps of:
selecting a diatomaceous earth ore with alumina content from about 3.0 and about 4.5 wt.-% and iron oxide content of from about 1.2 to about 2 wt.-% and a centrifuged wet density of less than about 0.32 g/l (about 20.0 lb/ft³);
simultaneously milling and flash-drying the diatomaceous earth ore;
beneficiating the milled and flash-dried diatomaceous earth ore;
blending the beneficiated diatomaceous earth ore with a fluxing agent;
solubilizing the fluxing agent with atomized water;
calcining the blended diatomaceous earth ore and the solubilized fluxing agent at a temperature of about 677° C. to about 1093° C. (about 1250° F. to about 2000° F.) for a time period ranging from about 20 minutes to about 40 minutes to produce an initial diatomaceous earth powder;
air-classifying the initial diatomaceous earth powder to produce a first fraction comprising the diatomaceous earth functional filler product and a second fraction comprising coarse particles;
further milling the coarse particles to produce additional diatomaceous earth powder; and
re-circulating the additional diatomaceous earth powder to blend the additional diatomaceous earth powder with the initial diatomaceous earth powder.

13. The method of claim 12, wherein solubilizing the fluxing agent comprises solubilizing the fluxing agent with about 5.0 wt.-% to about 15 wt.-% of the atomized water, wherein the wt.-% of the atomized water is on the basis of the blended diatomaceous earth ore and the fluxing agent.

14. The method of claim 12, wherein calcining the blended diatomaceous earth ore and the solubilized fluxing agent comprises calcining the blended diatomaceous earth ore and the solubilized fluxing agent at a temperature of about 760° C. to about 1093° C. (about 1400° F. to about 2000° F.).

15. The method of claim 12, wherein the air-classifying comprises air-classifying to produce a first fraction comprising a diatomaceous earth functional filler product having a Hegman gauge value of from about 1.0 to about 4.0.

16. The method of claim 12, wherein the blending of the beneficiated diatomaceous earth ore with the fluxing agent comprises blending the beneficiated diatomaceous earth ore with soda ash.

17. A method for manufacturing a diatomaceous earth functional filler product having detectable crystalline silica comprising the steps of:
selecting a diatomaceous earth ore with alumina content of less than about 3.0 wt.-% and iron oxide content of less than about 1.7 wt.-% and a centrifuged wet density of less than about 0.32 g/l (about 20.0 lb/ft³);
simultaneously milling and flash-drying the diatomaceous earth ore;
beneficiating the milled and flash-dried diatomaceous earth ore;
blending the beneficiated diatomaceous earth ore with a fluxing agent;
calcining the blended diatomaceous earth ore and the fluxing agent at a temperature of about 760° C. to about 1177° C. (about 1400° F. to about 2150° F.) for a time period ranging from about 20 minutes to about 40 minutes to produce an initial diatomaceous earth powder;
air-classifying the initial diatomaceous earth powder to produce a first fraction comprising the diatomaceous earth functional filler product and a second fraction comprising coarse particles;
further milling the coarse particles to produce additional diatomaceous earth powder; and
re-circulating the additional diatomaceous earth powder to blend the additional diatomaceous earth powder with the initial diatomaceous earth powder.

18. The method of claim 17, wherein calcining the blended diatomaceous earth ore and solubilized fluxing agent comprises calcining the blended diatomaceous earth ore and solubilized fluxing agent at a temperature of 820° C. to about 1093° C. (about 1510° F. to about 2000° F.).

19. The method of claim 17, wherein the step of air-classifying comprises air-classifying to produce a first fraction comprising a diatomaceous earth functional filler product having a Hegman gauge value of from about 1.0 to about 4.0.

20. The method of claim 17, wherein the blending the beneficiated diatomaceous earth ore with the fluxing agent comprises blending the beneficiated diatomaceous earth ore with soda ash.
